(19) United States
(12) Patent Application Publication
(10) Pub. No.: US 2009/0239081 A1
(43) Pub. Date: Sep. 24, 2009

(54) Method for welding two opaque elements of polymer material stable at high temperatures

(75) Inventors: Jean-Pierre Habas, Saint Faust (FR); Maxime Ricbourg, Pau (FR); Maria Madre Sediles, Zaragoza (ES); Andres Sotelo Mieg, Zaragoza (ES); Pascal Pignolet, Nousty (FR)

Correspondence Address: Davidson, Davidson & Kappel, LLC, 485 7th Avenue, 14th Floor, New York, NY, 10018, US

(73) Assignee: ALSTOM TRANSPORT SA, Levallois-Perret (FR)

(21) Appl. No.: 12/287,448

(22) Filed: Oct. 9, 2008

(30) Foreign Application Priority Data
Oct. 10, 2007 (FR) 07 58190

(51) Int. Cl. B32B 27/36; B32B 37/00; B32B 27/00

(52) U.S. Cl. 428/412; 156/272.8; 428/473.5; 428/704; 428/702; 428/697; 428/524

(57) ABSTRACT

A method for welding two opaque elements of polymer material stable at high temperatures including the following steps: preparing a lower element of opaque polymer material which is stable at high temperatures and to which is added a carbon powder in such a manner that the lower element is capable of absorbing laser radiation, preparing an upper element of polymer material which is stable at high temperatures, laser-welding the lower element and the upper element by laser radiation passing through the upper element and bringing about the welding at the interface between the upper element and the lower element. The upper element is made, during its preparation, opaque with respect to visible radiation and transparent with respect to laser radiation by adding a pigment to the polymer material, the pigment which is of the mineral or organic type not modifying the properties of the polymer material, being transparent with respect to laser radiation and stable at high temperatures.

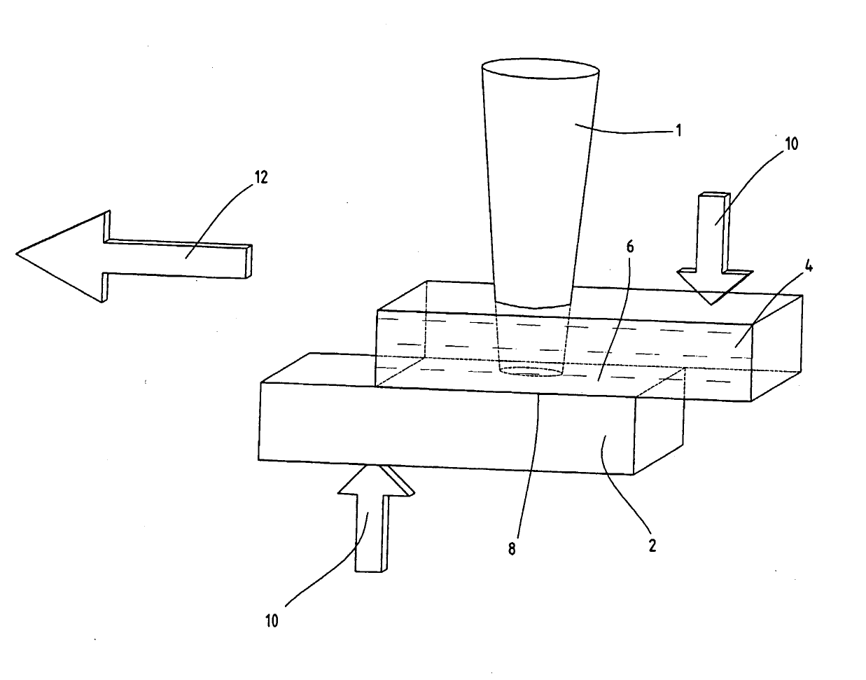

This claims the benefit of French Patent Application No. 07 58190, filed on Oct. 10, 2007 and hereby incorporated by reference herein.

The present invention relates to a method for welding two opaque elements of polymer material stable at high temperatures, of the type comprising the following steps:
preparing a lower element of polymer material which is stable at high temperatures and to which is added a carbon powder in such a manner that the lower element is opaque with respect to visible light radiation and is capable of absorbing laser radiation,
preparing an upper element of polymer material which is stable at high temperatures,
laser-welding the lower element and upper element by means of laser radiation passing through the upper element and bringing about the welding at the interface between the upper element and the lower element.

The invention also relates to an assembly of elements of thermoplastic material which is stable at high temperatures and an encapsulation device, or casing, of a power converter comprising such an assembly.

### BACKGROUND

In known power converters, the encapsulation devices or the casing of the converters comprise(s) an assembly of a plurality of elements of polymer material which are assembled together by means of a material which forms an adhesive and tight joint, such as silicone. These elements are, for example, assembled so as to form protective covers which include in their thickness conduits for cooling the energy converter. The power converter may involve temperatures substantially higher than 250° C. but does not allow any thermal drift. As such, the conduits have a heat-exchange fluid or cooling liquid such as a mixture of water and glycol flowing through them.

However the adhesive joint is not satisfactory for ensuring in the long term complete tightness between the elements of the casing owing to the physical and chemical properties thereof. Therefore, leaks of the cooling liquid result and may lead to problems involving short-circuits of the power converter.

In order to overcome this disadvantage, an ideal solution would be to weld the polymer material elements to each other. Thus, the assembly zones between the elements would be completely tight owing to the weld which brings about continuity of material in the assembly zone and therefore a polymer material joint having the same physical and chemical properties as the assembled elements.

However, laser-welding two opaque elements of polymer material which are stable at high temperatures presents a problem because it is necessary to ensure that the laser radiation passes through one of the elements and brings about the weld at the interface between the two elements without modifying the electrical, mechanical and chemical properties of the polymer materials.

Document WO-2006/08 56 43 describes a method for welding two polymer material elements, one of which is made opaque with respect to visible radiation and laser radiation and the other of which is made opaque with respect to visible radiation and transparent with respect to laser radiation by the addition of a colorant of the anthraquinone type. Such a colorant allows welding of technical polymers which have a melting point and an operating temperature which is less than the degradation temperature of the colorant which occurs from 250° C. Such a welding method does not allow welding of polymers whose operating temperature is very high, particularly above 300° C.

### SUMMARY OF THE INVENTION

One of the objectives of the invention is to overcome this problem by providing a method for welding two opaque elements, wherein the welding is carried out at the interface between the two elements and the properties of the materials of the elements are not modified.

To that end, the invention relates to a method of the above-mentioned type, wherein the upper element is made, during its preparation, opaque with respect to visible radiation and transparent with respect to laser radiation by adding a pigment to the polymer material, the pigment which is of the mineral or organic type not modifying the properties of the polymer material, being transparent with respect to laser radiation and stable at high temperatures.

According to other features of the method:
the upper element and the lower element may be pressed against each other during the laser welding;
the polymer materials of the lower element and upper element and the pigment added to the upper element may be stable at temperatures of at least 250° C.;
the polymer materials of the lower element and upper element may belong to the family including:
polyetherimides,
thermoplastics with a sulphone bond such as polysulphone, polyethersulphone and other derivatives,
polyetheretherketones,
phenylene polysulphide,
polycarbonate,
formulations obtained by mixing or co-reacting the above-mentioned compounds,
the pigment may be an oxide of cobalt and aluminium (Al₂O₃, CoO) or cobalt oxide alone (CoO) or cobalt phosphate (Co₃(PO₄)₂) or manganese violet;
a laser source may be moved above a zone for assembling the two elements so that the laser radiation which is emitted by the laser source passes over the assembly zone, and
the carbon powder mixed to the polymer of the lower element may be a micrometric carbon powder.

The invention also relates to an assembly of elements of thermoplastic material stable at high temperatures, comprising a plurality of polymer material elements which are opaque with respect to visible light radiation and stable at high temperatures, wherein at least one of the elements comprises a pigment which is added to the polymer material, the pigment which is of the mineral or organic type not modifying the properties of the polymer material, being transparent with respect to laser radiation and stable at high-temperatures.

According to other features of the assembly:
the assembly zones between the elements may be tight;
the assembly may be electrically insulating; and
the elements may be assembled together by a welding method as defined above.

The invention also relates to a casing of a power converter comprising at least one assembly as described above.

The invention also relates to a polymer material which is opaque with respect to visible light radiation and which is stable at high temperatures, comprising a pigment which is added to the polymer material, the pigment which is of the mineral or organic type not modifying the properties of the polymer material, being transparent with respect to laser radiation and stable at high temperatures so that the polymer material is transparent with respect to laser radiation.

The invention also relates to the use of a polymer material as described above in a welding method as described above.

### BRIEF DESCRIPTION OF THE DRAWINGS

Other aspects and advantages of the invention will be appreciated from a reading of the following description which is given by way of example and with reference to the appended FIGURE, which is a schematic illustration of a step for laser-welding two elements.

### DETAILED DESCRIPTION

With reference to the single FIGURE, there is described the laser welding of a lower element 2 to an upper element 4 by means of laser radiation 1 from a laser source (not illustrated).

The lower element 2 and the upper element 4 are constructed from the same thermoplastic polymer material which is stable at high temperatures. That material belongs, for example, to the group of polyetherimides, thermoplastics with a sulphone bond, such as polysulphone or polyethersulphone and their derivatives, polyetheretherketone (PEEK), or phenylene polysulphide (PPS) or any other thermoplastic materials which are high-performance, in particular amorphous.

The lower element 2 is made opaque with respect to laser radiation and to visible radiation by means of a micrometric carbon powder mixed with the polymer material. The term “opaque with respect to laser radiation and to visible radiation” is intended to mean that visible light radiation or laser radiation does not pass through the lower element 2. The lower element 2 comprises, for example, 0.6% by volume of micrometric carbon powder (grains having a diameter of between 2 and 15 μm) mixed with a polymer. The carbon powder absorbs the laser radiation 1 which has the effect of heating and melting the surface 6 of the lower element 2 when it is subjected to the laser radiation 1.

The upper element 4 is made opaque with respect to visible radiation by means of a mineral pigment. That pigment has the characteristics of being quasi-transparent with respect to laser radiation 1, that is to say that it absorbs laser radiation only very slightly, and of being opaque with respect to visible light. Furthermore, that additive does not modify the properties of the polymer material of the upper element 4, in particular its mechanical, chemical and electrical properties. One of the mechanical properties not modified by the additive is, for example, the Young's modulus of the polymer material. Electrical properties which are not modified by the additive are, for example, the breakdown voltage and the interruption field of the polymer material. One of the chemical properties not modified by the additive is, for example, the chemical inertia of the polymer material, that is to say, its compatibility with other materials. The properties mentioned above are given only by way of non-limiting example.

The pigment is stable at very high temperatures, for example, greater than 800° C. and in particular greater than 1000° C. and can therefore be used with polymers whose operating temperature is very high, similarly to PEEK. The mineral pigment is, for example, a spinel of cobalt and aluminium oxide (Al₂O₃, CoO) or cobalt oxide alone (CoO) or cobalt phosphate (Co₃(PO₄)₂) or manganese violet. The upper element 4 comprises, for example, 0.14% by volume of pigment of the cobalt and aluminium oxide (Al₂O₃, CoO) type.

The polymer material of the lower element 2 and upper element 4 and the pigment of the upper element 4 are stable at temperatures of at least 250° C.

In order to carry out the welding, the upper element 4 is arranged on the surface 6 of the lower element 2 at an assembly zone 8.

The laser radiation 1 is emitted from the laser source above the upper element 4. Owing to the transparency of the pigment with respect to the laser radiation 1, the laser radiation passes through the upper element 4 and reaches the surface 6 of the lower element 2 in the assembly zone 8. Owing to the presence of the carbon powder in the lower element 2, the laser radiation 1 is absorbed in the region of the surface 6 and brings about melting of the material of the lower element 2, which produces the weld at the interface between the upper element 4 and the lower element 2.

The lower element 2 and upper element 4 are pressed against each other during the welding operation, as illustrated by the arrows 10 of the FIGURE.

The laser source is further movable in such a manner that the laser radiation 1 passes over the assembly zone 8 and produces the weld over that entire zone, as illustrated by the arrow 12 of the FIGURE.

The elements 2 and 4 may be of any shape. The positioning of the elements relative to each other is brought about by means of a three-axis table for simple geometry, for example, for substantially planar elements. For complex geometry, the laser radiation is provided by means of optical fibres which allow precise positioning of the laser radiation 1 at the assembly zone 8.

The laser source is, for example, a continuous emission diode which emits in the visible range or in the near-infrared range, preferably having a wavelength substantially equal to 808 nm. A single passage of laser radiation is sufficient to bring about the weld at a pass speed of substantially between 0.1 mm·s⁻¹ and 1 mm·s⁻¹, preferably substantially equal to 0.5 mm·s⁻². The laser beam is homogeneous and is of substantially rectangular shape, the rectangle having a width substantially between 4 and 5 cm and a length substantially between 0.5 mm and 5 mm. The power of the laser is substantially between 100 W and 500 W, preferably substantially equal to 350 W. The laser diode may be supplied with a current of substantially between 10 A and 50 A, preferably between 20 A and 30 A, which confers on it a power density of substantially between 0.8 W·mm⁻¹ and 1.6 W·mm⁻¹.

The method described above therefore allows the welding of two elements which are opaque with respect to visible light to be carried out without modifying the electrical, mechanical and chemical characteristics of the polymer materials of the elements. In particular, it is possible to carry out the welding of two elements which are stable at very high temperatures. However, the method may be used with any type of polymer material, and particularly technical polymers having a lower melting temperature. The addition of a pigment therefore represents a more “universal” solution than using a colorant for welding any type of polymer materials. The use of a colorant limits the type of polymer materials which can be welded owing to the limited thermal stability of the colorant. With a colorant, only technical polymers having a lower melting temperature can be welded together whilst using a pigment allows, in addition, the welding of polymers whose operating temperature is very high.

Furthermore, the weld bead produced is completely tight, given that the elements are connected to each other by a continuous extent of the same material and this bead has the same characteristics as the lower element 2 and upper element 4. The overall quality of the weld joint may be greatly improved by using a lateral rim of PTFE which conforms to the peripheral shape of the elements to be welded. That outer template prevents any discharge of plastics material. It also prevents the formation of bubbles within the weld bead, which could be detrimental to the electrical operation (partial discharges).

The method described above has particular applications in constructing assemblies of elements of polymer material which are stable at high temperatures, in particular casings of power converters. Such a casing comprises at least one assembly of a plurality of elements which are assembled together in accordance with the method described above.

Those converters discharge great heat and the method allows the construction of a casing which withstands such temperatures which may be up to at least 250° C.

The assembled elements allow the construction of cooling channels, in which a cooling liquid flows, for example, formed by water and glycol. The sealing of the weld allows channels to be obtained without any risk of leaks and therefore short-circuits.

Furthermore, owing to the electrical properties of the elements assembled and the weld bead, the casing is an electrical insulator.

The assembly of elements of polymer material stable at high temperatures also has applications in other fields, such as the automotive industry, aeronautics, microelectronics, etc.

What is claimed is:

1-14. (canceled)

15. A method for welding two elements of polymer material which are opaque with respect to visible light radiation and stable at high temperatures, the method for welding comprising the following steps:
preparing a lower element of polymer material which is stable at high temperatures and adding a carbon powder in such a manner that the lower element is opaque with respect to the visible light radiation and capable of absorbing a laser radiation;
preparing an upper element of polymer material which is stable at high temperatures; and
laser-welding the lower element and the upper element by laser radiation passing through the upper element and bringing about the welding at an interface between the upper element and the lower element,
wherein during the preparation of the upper element, making the upper element opaque with respect to visible light radiation and transparent with respect to the laser radiation by adding a pigment to the polymer material, the pigment being of a mineral or an organic type not modifying the properties of the polymer material, being transparent with respect to laser radiation and stable at high temperatures.

16. The method for welding as recited in claim 15 wherein the upper element and the lower element are pressed against each other during the laser welding.

17. The method for welding as recited in claim 15 wherein the polymer materials of the lower element and upper element and the pigment added to the upper element are stable at temperatures of at least 250° C.

18. The method for welding as recited in claim 15 wherein the polymer materials of the lower element and the upper element belong to a family comprising:
polyetherimides,
thermoplastics with a sulphone bond,
polyetheretherketones,
phenylene polysulphide,
polycarbonate,
wherein formulations are obtained by mixing or co-reacting the above-mentioned compounds of the family.

19. The method for welding as recited in claim 18 wherein the thermoplastics are polysulphone, polyethersulphone and other derivatives.

20. The method for welding as recited in claim 15 wherein the pigment is an oxide of cobalt and aluminum, cobalt oxide alone, cobalt phosphate or manganese violet.

21. The method for welding as recited in claim 15 further comprising moving a laser source above an assembly zone for assembling the lower element and the upper element so that the laser radiation emitted by the laser source passes over the assembly zone.

22. The method for welding as recited in claim 15 wherein the carbon powder mixed to the polymer of the lower element is a micrometric carbon powder.

23. An assembly of elements of thermoplastic material stable at high temperatures, comprising a plurality of polymer material elements which are opaque with respect to visible light radiation and stable at high temperatures, wherein at least one of the elements comprises a pigment which is added to the polymer material, the pigment being a mineral or organic type not modifying the properties of the polymer material, transparent with respect to laser radiation and stable at high temperatures.

24. The assembly as recited in claim 23 further comprising assembly zones between the elements, the assembly zones being tight.

25. The assembly as recited in claim 23 wherein the assembly is electrically insulating.

26. The assembly as recited in claim 23 wherein the elements are assembled together by a welding method as recited in claim 15.

27. A casing of a power converter, wherein the casing comprises at least one assembly as recited in claim 23.

28. A polymer material opaque with respect to visible light radiation and is stable at high temperatures, wherein the polymer material comprises a pigment which is added to the polymer material, the pigment being of a mineral or an organic type not modifying the properties of the polymer material, being transparent with respect to laser radiation and stable at high temperatures so that the polymer-material is transparent with respect to laser radiation.

29. A use of a polymer material as recited in claim 28 in the welding method as recited in claim 15.
